(19) United States
(12) Patent Application Publication
(10) Pub. No.: US 2017/0261802 A1
(43) Pub. Date: Sep. 14, 2017

(54) Backlight Module And Display Device

(71) Applicant: Shenzhen China Star Optoelectronics Technology Co., Ltd., Shenzhen, Guangdong (CN)

(72) Inventors: Dehua LI, Shenzhen, Guangdong (CN); Gang YU, Shenzhen, Guangdong (CN); Yuchun HSIAO, Shenzhen, Guangdong (CN)

(73) Assignee: Shenzhen China Star Optoelectronics Technology Co., Ltd., Shenzhen, Guangdong (CN)

(21) Appl. No.: 14/907,864

(22) PCT Filed: Dec. 24, 2015
(86) PCT No.: PCT/CN2015/098747

§ 371 Date: Jan. 27, 2016

(30) Foreign Application Priority Data
Nov. 9, 2015 (CN) 201510759676.3

(51) Int. Cl. G02F 1/1333

(52) U.S. Cl. CPC G02F 1/133308; G02F 2001/133317; G02F 2001/13332

(57) ABSTRACT

The backlight module contains a back plate and a middle frame. The middle frame contains at least three positioning strips positioned along three edges on a side of the back plate facing a light emission face of the backlight module. A display device containing the backlight module is also disclosed. The back plate provides locking mechanisms involving side walls and locking pieces, and the separate strips of the middle frame are slid into position along the back plate and reliably locked. There is no need to use bolts or other fastening means, reducing the difficulty in assembly/disassembly. The thinning of the backlight module and the display device is effectively achieved.

### BACKGROUND OF THE INVENTION

1. Field of the Invention

The present invention relates to display technologies, and in particular to a backlight module and a display device.

2. The Related Arts

As liquid crystal technology advances, thinning the display module is major product trend. An existing display module mainly contains a display panel and a backlight module. The thinning of the display module is achieved mainly through the thinning of the backlight module. The backlight module mainly contains a metallic frame, reflection plate, backlight plate, and optical films. The thinning of the backlight module is achieved mainly through the reduction of the thickness of these components. However, thickness reduction has specific limitation depending on the component involved. The integration of these re-designed components becomes more complicated. The configuration of various connectors offsets the above-mentioned thinning effort and the assembly/disassembly is tedious.

### SUMMARY OF THE INVENTION

To obviate the shortcoming of the prior art, the present invention provides a backlight module of convenient assembly/disassembly and of fewer connectors.

To achieve the objective, the present invention teaches the following technical solutions.

A backlight module contains a back plate and a middle frame. The middle frame contains at least three positioning strips positioned along three edges on a side of the back plate facing a light emission face of the backlight module.

Each positioning strip is locked to the back plate.

The back plate contains at least a main piece, a number of side walls extended from the main piece's edges toward the light emission face, and a number of locking pieces extended inward from each side wall. Each positioning strip has at least a portion plugged into a gap between the main piece and the locking pieces on a side wall.

Each positioning strip is locked to the side wall or the locking pieces on the side wall.

Each locking piece has a first locking opening and each positioning strip has a number of first protrusions along a front side, each for plugging into the first locking opening of a corresponding locking piece.

Each first protrusion has a slant bottom side.

The middle frame further contains two flexible connection elements, each end-to-end connecting two neighboring positioning strips.

The middle frame further contains a bridging strip along an edge on the side of the back plate facing the light emission face, and the bridging strip and the positioning strips jointly form a rectangular shape.

The bridging strip has an L-shaped cross-section, and the bridging strip is attached and fixed to a top side of the back plate and two vertical positioning strips' top sides.

Another objective of the present invention is to provide a display device containing the above-described backlight module, a liquid crystal panel configured in front of the backlight module, and a front frame surrounding the liquid crystal display panel.

According to the present invention, the middle frame of the backlight module is designed to have separate strips. The back plate on the other hand provides locking mechanisms involving side walls and locking pieces so that the separate strips of the middle frame are slid into position along the back plate and reliably locked. There is no need to use bolts or other fastening means, reducing the difficulty in assembly/disassembly. The thinning of the backlight module and the display device therefor is effectively achieved.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a perspective diagram showing a display device according to a first embodiment of the present invention;

FIG. 2 is a perspective break-down diagram showing the display device of FIG. 1;

FIG. 3 is a perspective break-down diagram showing a middle frame of a backlight module of the display device of FIG. 1;

FIG. 4 is a perspective enlarged diagram showing the details within a circled area A indicated in FIG. 3;

FIG. 5 is a schematic cross-sectional diagram showing the installation of the middle frame of FIG. 3;

FIG. 6 is a schematic cross-sectional diagram showing the display device of FIG. 1;

FIG. 7 is a schematic cross-sectional diagram showing a different engagement between a back plate and a middle frame of the display device of FIG. 1;

FIG. 8 is a front-view diagram showing a back plate and part of a middle frame of a backlight module according to a second embodiment of the present invention;

FIG. 9 is a perspective diagram showing the process of installing a middle frame of the backlight module of FIG. 8;

FIG. 10 another perspective diagram showing the process of installing a middle frame of the backlight module of FIG. 8; and

FIG. 11 is a perspective enlarged diagram showing the details within a circled area B indicated in FIG. 10.

### DETAILED DESCRIPTION OF THE PREFERRED EMBODIMENTS

### First Embodiment

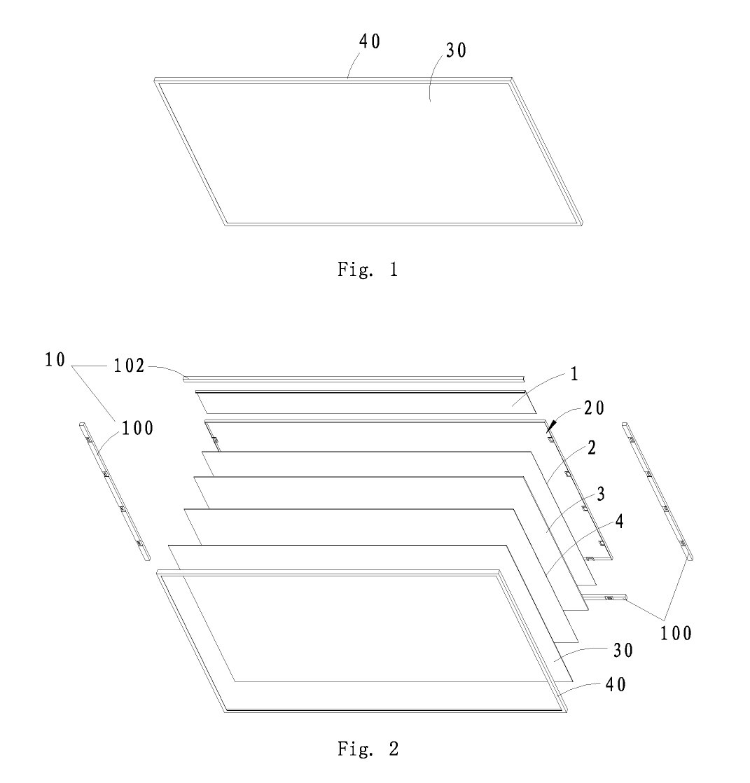

As illustrated in FIGS. 1 and 2, a display device according to a first embodiment of the present invention contains a backlight module (not numbered), a liquid crystal panel 30 in front of the backlight module, and a front frame 40 surrounding the liquid crystal panel 30. Specifically, the liquid crystal panel 30 is configured to a light emission face of the backlight module, and is further positioned and protected by the front frame 40.

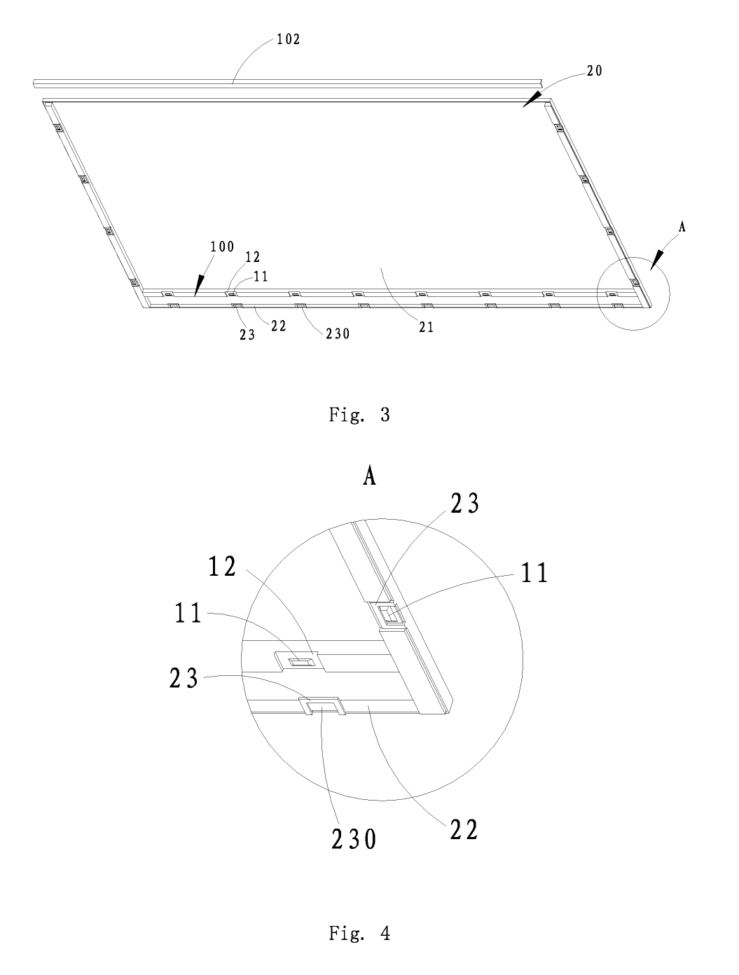

In the present embodiment, the backlight module contains a middle frame 10, a back plate 20, a light emitting diode (LED) lamp strip 1, a reflection plate 2, a light guide plate 3, and an optical film 4. As illustrated in FIG. 3, the middle frame 10 contains three positioning strips 100 and a bridging strip 102, which are positioned along the four edges on a side of the back plate 20 facing the light emission face, respectively. The positioning strips 100 are locked to the back plate 20 whereas the bridging strip 102 is fixed to the back plate 20 by adhesion or similar means. The bridging strip 102 has an L-shaped cross-section. After the positioning strips 100 are configured, the bridging strip 102 is attached and fixed to a top side of the back plate 20 and the top sides of the two vertical positioning strips 100.

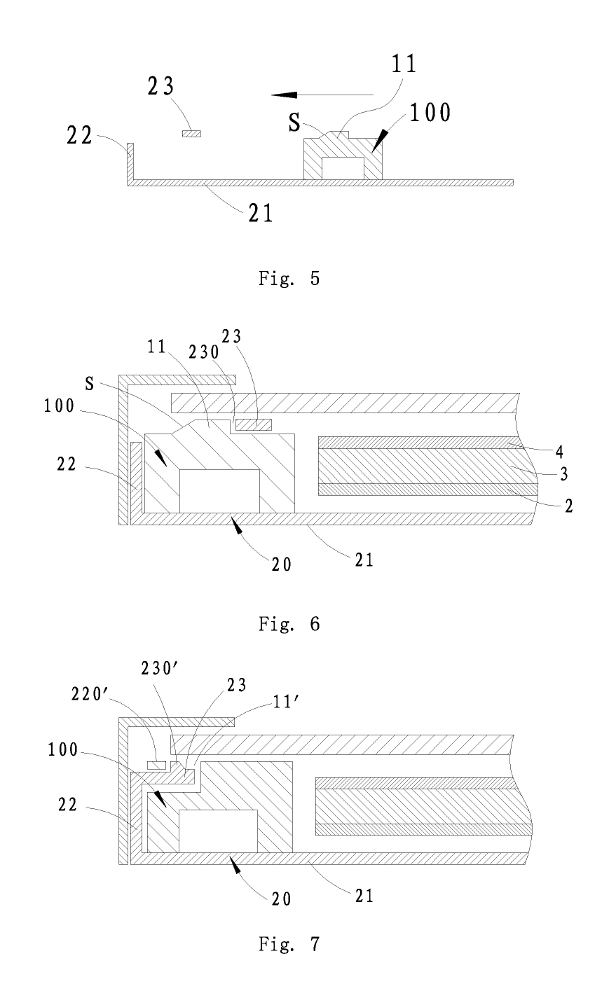

As illustrated in FIGS. 4 to 6, the back plate 20 contains a main piece 21, four side walls 22 extended from the four edges of the main piece 21 toward the light emission face, and a number of locking pieces 23 extended inward from the side walls 22. The side walls 22 are perpendicular to the main piece 21, and the locking pieces 23 are parallel to the main piece 21. Each positioning strip 100 has at least a portion plugged into a gap between the main piece 21 and some locking pieces 23, and is locked to a side wall 22 or to the locking pieces 23.

Specifically, as illustrated in FIG. 6, there are multiple locking pieces 23 configured at intervals along each side wall 22. Each locking pieces 23 has a first locking opening 230. Correspondingly, each positioning strip 100 has a number of first protrusions 11 at intervals along a front side, each for plugging into a first locking opening 230.

As illustrated in FIG. 3, the assembly of the middle frame 10 is as follows. The two positioning strips 100 along the two shorter lateral edges of the back plate 20 are first installed. The positioning strip 100 along the bottom longer edge of the back plate 20 is then installed. Due to the positioning mechanism provided by the side walls 22 and the locking pieces 23, each positioning strip 100 can be slid into position along the main piece 21. After each positioning strip 100 is inserted into the gap between the main piece 21 and the locking pieces 23, the first protrusions 11 are plugged into corresponding first locking openings 230, respectively. In the process, the main piece 21 and the locking pieces 23 provides guidance for each positioning strip 23. Preferably, each first protrusion 11 has a slant bottom side S so that, when a positioning strip 100 is slid into position, the slant bottom side S of a first protrusion 11 raises a top edge of a corresponding locking piece 23 and then the first protrusion 11 is smoothly plugged into the first locking opening 230 of the locking piece 23. Then, the L-shaped bridging strip 101 is installed so as to confine the LED lamp strip 1, the reflection plate 2, the light guide plate 3, and the optical film 4. In alternative embodiments, it is possible to have a single locking piece 23 configured with a number of first locking openings 230.

After the backlight module is assembled, the liquid crystal panel 30 is attached to a front side of the backlight module, and finally the front frame 40 is installed. As the liquid crystal panel 30 is attached to the front sides of the locking pieces 23, the locking pieces 23 are further confined and as such the middle frame 10 is more reliably positioned, achieving enhanced assembly reliability.

As illustrated in FIG. 7, an alternative engagement between the positioning strips 100 and the back plate 20 is as follows. Each locking piece 23 has a second protrusion 230′ on a front side. Each positioning strip 100 has a corresponding socket (not numbered) along a bottom side and a second locking opening 11′ on a front side. As such, as the locking piece 23 is plugged into the corresponding socket of a positioning strip 100, the second protrusion 230′ is locked to the second locking opening 11′. To smooth the installation of the positioning strip 100, each second protrusion 230′ has a slant top side.

According to the present invention, the middle frame is designed to contain separate positioning strips and bridging strip. The back plate provides side walls and locking pieces, the positioning strips can be slid into position along the main piece of the back plate and then locked to the back plate. There is no need to use bolts or other fastening means, reducing the difficulty in assembly/disassembly. In addition, as there is no irregular mechanism and bolt hole for fixing the middle frame along the back plate's circumference, the thinning of the backlight module and the display device can be effectively achieved.

### Second Embodiment

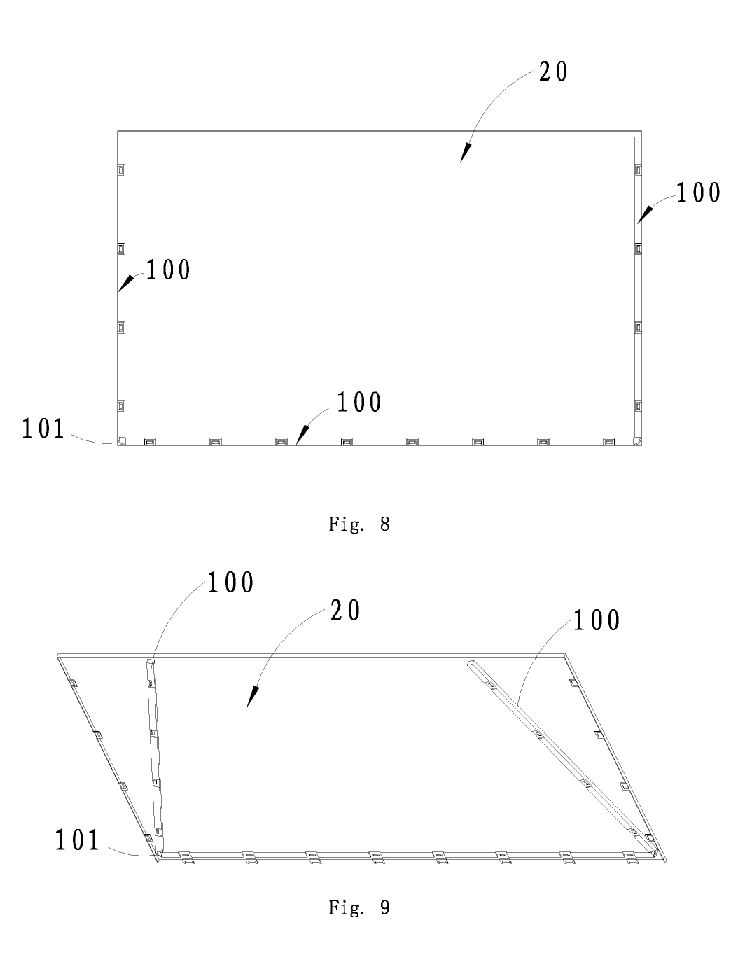

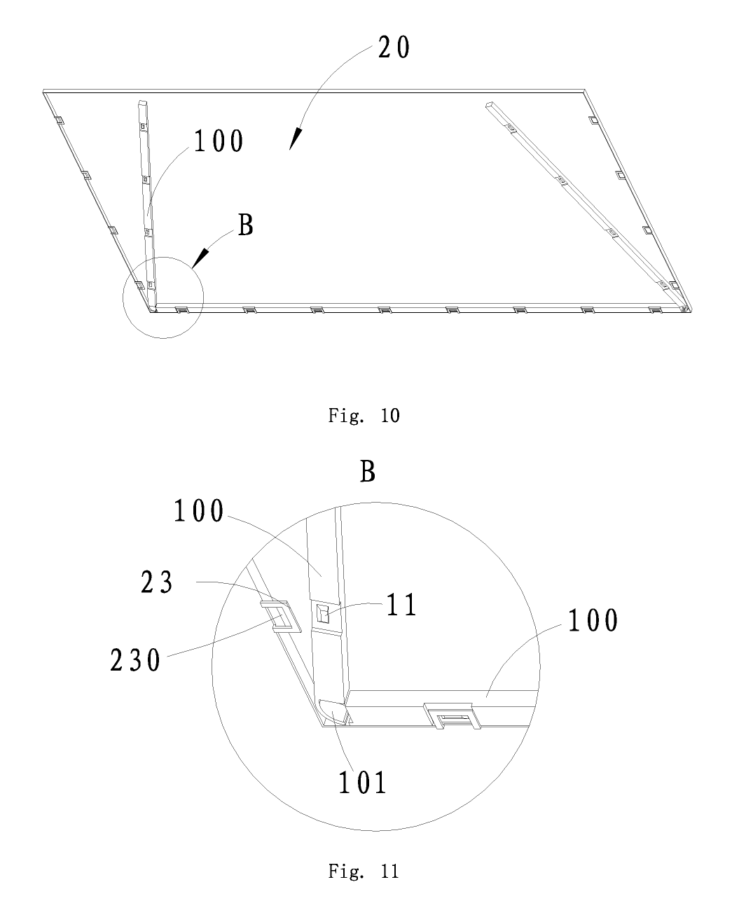

As illustrated in FIGS. 8 to 11, in contrast to the previous embodiment, the present embodiment has the three positioning strips 100 end-to-end connected with flexible connection elements 101. Each connection element 101 can be thin pieces connecting the neighboring ends of two positioning strips 100. During assembly, the two vertical positioning strips 100 can be tiled inward and the bottom positioning strip 100 is first slid along the main piece 21 toward a side wall 22. After the bottom positioning strip 100 is installed, the two vertical positioning strips 100 are then slid toward their respective side walls 22 for installation. This embodiment can effectively reduce the interference with the back plate 20 when the two vertical positioning strips 100 are installed. This is particularly suitable for display devices of smaller dimensions. The present embodiment can also achieve enhanced assembly efficiency, and reduced complexity and molding cost.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A backlight module, comprising:
a back plate; and
a middle frame comprising three positioning strips positioned along three edges on a side of the back plate facing a light emission face of the backlight module.

2. The backlight module as claimed in claim 1, wherein each positioning strip is locked to the back plate.

3. The backlight module as claimed in claim 1, wherein the back plate comprises a main piece, a plurality of side walls extended from the main piece's edges toward the light emission face, and a plurality of locking pieces extended inward from each side wall; and each positioning strip has at least a portion plugged into a gap between the main piece and the plurality of locking pieces on a side wall.

4. The backlight module as claimed in claim 3, wherein each positioning strip is locked to the side wall or the plurality of locking pieces.

5. The backlight module as claimed in claim 4, wherein each locking piece has a first locking opening; and, each positioning strip has a plurality of first protrusions along a front side, each for plugging into the first locking opening of a corresponding locking piece.

6. The backlight module as claimed in claim 5, wherein each first protrusion has a slant bottom side.

7. The backlight module as claimed in claim 1, wherein the middle frame further comprises two flexible connection elements, each end-to-end connecting two neighboring positioning strips.

8. The backlight module as claimed in claim 1, wherein the middle frame further comprises a bridging strip along an edge on the side of the back plate facing the light emission face; and the bridging strip and the positioning strips jointly form a rectangular shape.

9. The backlight module as claimed in claim 8, wherein the bridging strip has an L-shaped cross-section; and the bridging strip is attached and fixed to a top side of the back plate and two vertical positioning strips' top sides.

10. A display device comprising a backlight module, a liquid crystal panel configured in front of the backlight module, and a front frame surrounding the liquid crystal panel; wherein the backlight module comprises:
a back plate, and
a middle frame comprising three positioning strips positioned along three edges on a side of the back plate facing a light emission face of the backlight module.

11. The backlight module as claimed in claim 10, wherein each positioning strip is locked to the back plate.

12. The backlight module as claimed in claim 10, wherein the back plate comprises a main piece, a plurality of side walls extended from the main piece's edges toward the light emission face, and a plurality of locking pieces extended inward from each side wall; and each positioning strip has at least a portion plugged into a gap between the main piece and the plurality of locking pieces on a side wall.

13. The backlight module as claimed in claim 12, wherein each positioning strip is locked to the side wall or the plurality of locking pieces.

14. The backlight module as claimed in claim 13, wherein each locking piece has a first locking opening; and, each positioning strip has a plurality of first protrusions along a front side, each for plugging into the first locking opening of a corresponding locking piece.

15. The backlight module as claimed in claim 14, wherein each first protrusion has a slant bottom side.

16. The backlight module as claimed in claim 10, wherein the middle frame further comprises two flexible connection elements, each end-to-end connecting two neighboring positioning strips.

17. The backlight module as claimed in claim 10, wherein the middle frame further comprises a bridging strip along an edge on the side of the back plate facing the light emission face; and the bridging strip and the positioning strips jointly form a rectangular shape.

18. The backlight module as claimed in claim 17, wherein the bridging strip has an L-shaped cross-section; and the bridging strip is attached and fixed to a top side of the back plate and two vertical positioning strips' top sides.

19. A display device comprising a backlight module, a liquid crystal panel configured in front of the backlight module, and a front frame surrounding the liquid crystal panel; wherein the backlight module comprises
a back plate, and
a middle frame comprising three positioning strips positioned along three edges on a side of the back plate facing a light emission face of the backlight module and a bridging strip along an edge on the side of the back plate; and
the bridging strip and the positioning strips jointly form a rectangular shape.
